(19) United States
(12) Patent Application Publication
(10) Pub. No.: US 2021/0061516 A1
(43) Pub. Date: Mar. 4, 2021

(54) Structured Shake Sleeve

(71) Applicant: Richard Charles Russett, III, Celebration, FL (US)

(72) Inventor: Richard Charles Russett, III, Celebration, FL (US)

(21) Appl. No.: 17/097,683

(22) Filed: Nov. 13, 2020

Related U.S. Application Data
(63) Continuation-in-part of application No. 15/468,982, filed on Mar. 24, 2017.

(51) Int. Cl. B65D 23/08; B65D 25/34; A47G 23/02; A47J 43/27

(52) U.S. Cl. CPC B65D 23/0842; A47J 43/27; A47G 23/02; B65D 25/34

(57) ABSTRACT

This disclosure relates to a structured shake sleeve that goes around a beverage container, wherein the beverage container is used for the storing, mixing or blending of liquids for consumption, and wherein the unique design of the sleeve improves the texture and flavor of the liquid blended within beverage contained around which the sleeve is placed. Paired magnets in the sleeve that are positioned opposite to each other create a magnetic field between the two magnets and the magnetic field acts upon the liquid within the container to improve the flavor and texture of the liquid.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the Invention

This disclosure relates to a structured shake sleeve for a beverage container comprising the sleeve and a plurality of paired magnets, wherein the paired magnets have opposing poles, that improves the texture and flavor of the liquid blended within the beverage container, by having the paired magnets act upon the liquid within the beverage container.

### Background of the Invention

This application is a continuation in part of U.S. patent application Ser. No. 15/468,982 filed Mar. 24, 2017. The benefit of the earlier filing date of the aforementioned U.S. patent application Ser. No. 15/468,982 is hereby claimed.

Some beverage additives begin as a powder, liquid or gel and are blended with water prior to being consumed. The texture and flavor of these beverage additives detract from the drinkability and flavor of the resultant beverage. Other beverages contain impurities that impact the taste of the beverage. The present disclosure reveals a sleeve for a beverage container with a plurality of paired magnets within the sleeve for the purpose of mixing, blending, storing, or drinking a beverage, said beverage having an improved flavor as a result of the magnetic field created between the paired magnets, the magnetic field acts upon the liquid in the container to reorient the molecules of the liquid and improve the flavor and texture of the liquid.

Specifically, Water, the primary constituent of beverages is a polar molecule with negative and positive ends. A Magnet, which possesses positive and negative poles creates a magnetic field as energy flows between the poles. When two magnets (paired magnets) are placed within close proximity but do not touch, and are oriented such that the positive pole of one of the magnets faces the negative pole of the other magnet, a magnetic field is created between the two magnets. When a liquid containing water (a polar molecule), is placed within the magnetic field created by the paired magnets, the magnetic field acts on the water to cause the water molecules (and thus the liquid) to change from a random orientation to an oriented arrangement relative to the magnetic field. The magnetic field acting on the water molecules impacts the taste, texture, and solubility of the liquid that is being acted on by the magnetic field. See, Ling G. N. (2003). A new theoretical foundation for the polarized-oriented multilayer theory of cell water and for inanimate systems demonstrating long-range dynamic structuring of water molecules. Physiological chemistry and physics and medical NMR, 35(2), 91-130; Ebrahim, Shaban & Azab, Azab. (2017). Biological Effects of Magnetic Water on Human and Animals. Biomedical Sciences. 3. 78-85. 10.11648/j.bs.20170304.12; Ibrahim, I. H. (2006). Biophysical Properties of Magnetized Distilled Water. Physics Department-Faculty of Science, Egypt. J. Sol., Vol. (29), No (2); Gupta, N., & Bhat, M. (2011). Comparative Evaluation of 0.2 percent Chlorhexidine and Magnetized Water as a Mouth Rinse on Streptococcus mutans in Children. International journal of clinical pediatric dentistry, 4(3), 190-194. https://doi.org/10.5005/jp-journals-10005-1108; Lee, H. J., & Kang, M. H. (2013). Effect of the magnetized water supplementation on blood glucose, lymphocyte DNA damage, antioxidant status, and lipid profiles in STZ-induced rats. Nutrition research and practice, 7(1), 34-42. https://doi.org/10.4162/nrp.2013.7.1.34; Hafizi, L., Gholizadeh, M., Karimi, M., Hosseini, G., Mostafavi-Toroghi, H., Haddadi, M., Rezaiean, A., Ebrahimi, M., & Emami Meibodi, N. (2014). Effects of magnetized water on ovary, pre-implantation stage endometrial and fallopian tube epithelial cells in mice. Iranian journal of reproductive medicine, 12(4), 243-248; Al-Nimer, M. S., Neda, F., & Lateef, Z. W. (2010). Magnetized solutions altered the absorbance of tramadol hcl: uv-spectrophotometer study. Journal of basic and clinical pharmacy, 1(2), 119-123; Huang, Stephanie. (2012). Making Magnetic Yeast. PLoS biology. 10. e1001274. The magnetic field created by the pair of magnets may also impact other components of the liquid.

Several advantages result from the present disclosure including, first, when a beverage additive is mixed with water in the beverage container the resultant beverage produced is smoother and has a superior taste over the same beverage additive mixed in other containers; and second, when a beverage is stored in the container, the container causes the impurities in the container to be restricted.

### SUMMARY OF THE INVENTION

The present disclosure reveals a structured shake sleeve to go around a beverage container to improve the texture and flavor of the liquid blended within the beverage container, wherein the beverage container is a protein shakers bottle, water bottle, cup, mug, glass, baby bottle, cocktail shaker, bowl, bottle, jar, can, or other type of liquid holding container, wherein the structured shake sleeve comprises a sleeve and a plurality of paired magnets contained within the sleeve. A plurality of paired magnets is defined as at least one pair of magnets. Each magnet in a pair of magnets of the plurality of paired magnets is positioned in the beverage container such that one magnet is on one side of the beverage container while its pair is located on the opposite side of the beverage container and the magnets are oriented such that the positive pole of one magnet pair of magnets is facing the negative pole of the opposing magnet in the pair of magnets. The magnetic field created between each pair of paired magnets acts upon the liquid in the container to reorient the molecules in the liquid to improve the flavor and texture of the liquid.

In determining the placement of each pair of magnets in the plurality of magnets a center-point of the beverage container is identified based on the beverage container's dimensions and from the center-point Cartesian coordinates can be extrapolated. Thus, a positive x-axis intersects one of the sides of the plurality of sides of the beverage container and a negative x-axis intersects one of the sides of the plurality of sides of the beverage container; and a positive y-axis intersects one of the sides of the plurality of sides of the beverage container and a negative y-axis intersects one of the sides of the plurality of sides of the beverage container.

In a first embodiment of the plurality of paired magnets the first set of paired magnets is positioned along the x-axis wherein the first magnet of the pair of magnets is positioned along the positive x-axis, in the side of the sleeve and the other magnet of the pair of magnets is positioned along the negative x-axis in the opposite side of the sleeve.

In a second embodiment of the plurality of paired magnets there are two sets of paired magnets wherein the first set of paired magnets is positioned along the x-axis wherein the first magnet is positioned along the positive x-axis, in the side of the sleeve and the other magnet is positioned along the negative x-axis in the opposite side of the sleeve, while the second set of paired magnets is positioned along the y-axis, having the first magnet positioned along the positive y-axis in the side of the sleeve, 90 degrees off from the first set of paired magnets and the second magnet positioned along the negative y-axis on the opposite side of the sleeve.

Additional magnet sets in the plurality of magnets are possible, wherein each magnet in the set of magnets is positioned so as to oppose its pair.

### BRIEF DESCRIPTION OF THE SEVERAL VIEWS OF THE DRAWING

FIG. 1 is a view of the structured shake sleeve positioned around a beverage contained with the Cartesian coordinates interposed on the sleeve;

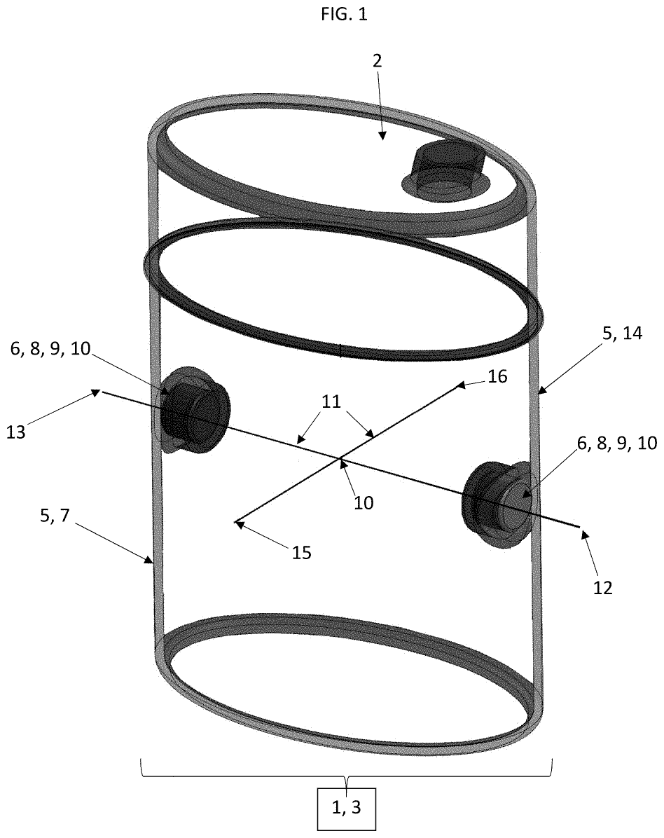

FIG. 2 is a view of the first embodiment of the structured shake sleeve including the first set of paired magnets of the plurality of paired magnets, wherein one of the magnets is positioned along the positive x-axis in the side of the sleeve and the other magnet of the pair of magnets is positioned along the negative x-axis; and

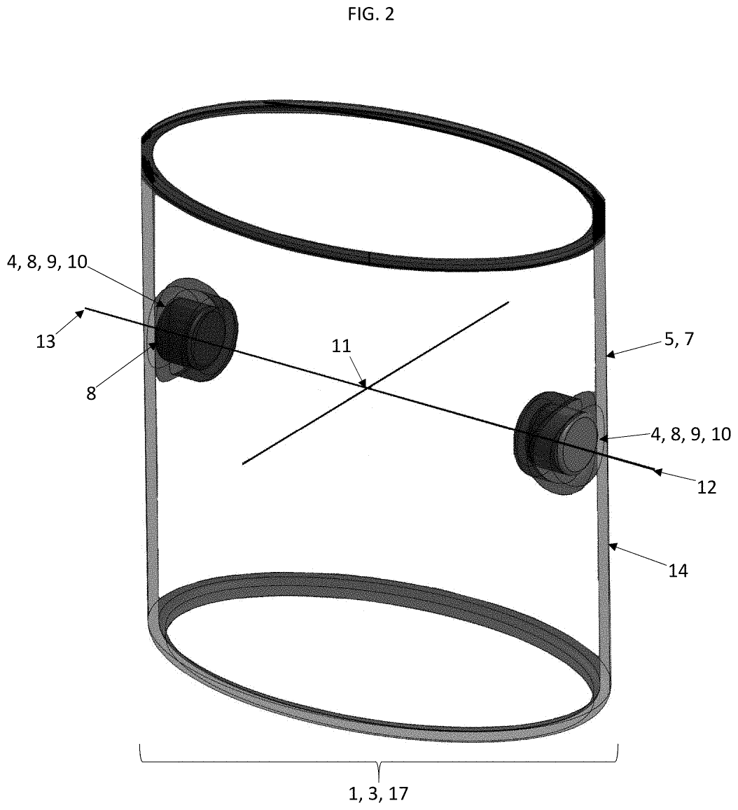

FIG. 3 is a view of the second embodiment of the structured shake sleeve including two pairs of paired magnets with the first set of paired magnets of the plurality of paired magnets, wherein one of the magnets is positioned along the positive x-axis in the side of the sleeve and the other magnet of the first pair of paired magnets is positioned along the negative x-axis in on the opposite side of the sleeve, and wherein there is the second set of paired magnets of the plurality of paired magnets, such that one of the magnets of the second set of paired magnets is positioned along the positive y-axis in the side of the sleeve 90 degrees from the first set of paired magnets and the other magnet of the second set of paired magnets is positioned along the negative y-axis in the sleeve, opposite the first magnet in the second set of paired magnets.

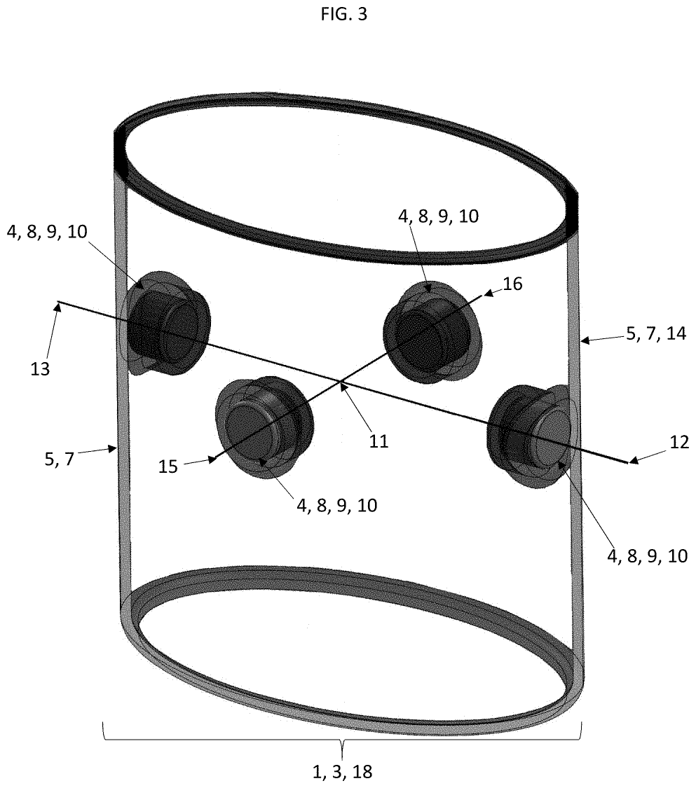

### DETAILED DESCRIPTION OF THE INVENTION

The present disclosure reveals a structured shake sleeve 1 to be placed around a beverage container 2 to improve the texture and flavor of the liquid blended within the beverage container. The beverage container 2 is a is a protein shakers bottle, water bottle, cup, mug, glass, baby bottle, cocktail shaker, bowl, bottle, jar, can, or other type of liquid holding container and comprises a plurality of sides and is capable of receiving and holding liquids, powders or gels. The structured shake sleeve 1 comprises a sleeve 3 with a plurality of sides 6 and a plurality of paired magnets 4, wherein the plurality of paired magnets 4 is defined by at least one pair of magnets 4. Each magnet 8 in a pair of magnets 9 of the plurality of paired magnets 4 is positioned in the sleeve 3 such that one magnet 8 is in one location of the sleeve 3 while another magnet 8 in the pair of magnets 9 is located on the opposite location around the sleeve 3 and the magnets in each pair of magnets are oriented such that the positive pole of one magnet pair of magnets is facing the negative pole of the opposing magnet in the pair of magnets. Each pair of magnets 9 in the sleeve 3 act upon each other to create a magnetic field within the liquid in the beverage container 2, said magnet field then acts upon the liquid in the beverage container 2 to improve the flavor and texture of the liquid.

In determining the placement of each pair of magnets 9 in the plurality of paired magnets 4 a center-point 10 of the sleeve 3 is identified based on the sleeve's 3 dimensions and from the center-point 10, Cartesian coordinates 11 can be extrapolated. Thus, a positive x-axis 12 intersects one of the sides 5 of the plurality of sides 6 of the sleeve 3 and a negative x-axis 13 intersects one of the sides 5 of the plurality of sides 6 of the sleeve 3; and a positive y-axis 15 intersects one of the sides 5 of the plurality of sides 6 of the sleeve 3, and is 90 degrees off from the x-axis as is established by the positive x-axis 12 and the negative x-axis 13 and a negative y-axis 16 intersects one of the sides 5 of the plurality of sides 6 of the sleeve 3.

In a first embodiment 17 of the plurality of paired magnets 4 the first set of paired magnets 9 is positioned along the x-axis wherein the first magnet 8 is positioned along the positive x-axis 12, in the side 5 of the sleeve 3 and the other magnet 8 is positioned along the negative x-axis 13 in opposite side 7 of the sleeve 3.

In a second embodiment 18 of the plurality of paired magnets 4 there are two sets of paired magnets 9 wherein the first set of paired magnets 9 is positioned along the x-axis wherein the first magnet 8 is positioned along the positive x-axis 12, in the side 5 of the sleeve 3 and the other magnet 8 is positioned along the negative x-axis 13 in the opposite side 7 of the sleeve 3, while the second set of paired magnets 9 is positioned along the y-axis, having the first magnet 8 positioned along the positive y-axis 15 in one side 14 of the plurality of sides 6 of the sleeve 3, 90 degrees off from the first set of paired magnets, and the second magnet 8 is positioned along the negative y-axis 16 in the opposite side 7 of the plurality of sides 5 of the sleeve 3.

Additional pairs of magnets 9 in the plurality of paired magnets 4 are possible, wherein each magnet 8 in the set of magnets 9 is positioned so as to oppose a magnet 8.

What is claimed:

1. A structured shake sleeve that fits around a beverage container wherein the beverage container is used for mixing, blending, storing, or drinking of liquids and wherein the structured shake sleeve consists of:
a sleeve
a plurality of sides in the sleeve and a first pair of paired magnets positioned in the sleeve;
wherein the first pair of paired magnets of the sleeve improves the texture and flavor of the liquid blended within the beverage container;
wherein the first pair of paired magnets consists of a first magnet and a second magnet;
wherein the first pair of paired magnets is positioned such that the first magnet of the first pair of paired magnets is positioned in one of the sides of the plurality of sides of the sleeve while the second magnet of the first pair of paired magnets is positioned in an opposite side of the sleeve;
wherein the first magnet in the pair of magnets is oriented so that its positive pole is oriented toward and facing the negative pole of the second magnet that is located on the opposite location around the sleeve;
wherein the pair of magnets in the sleeve act upon each other to create a magnetic field within the liquid in the beverage container; and
said magnet field then acts upon the liquid in the beverage container to improve the flavor and texture of the liquid.

2. The structured shake sleeve of claim 1 wherein there is a second pair of paired magnets in the sleeve;
wherein the second pair of paired magnets consists of a first magnet and a second magnet;
wherein the first pair of paired magnets of the sleeve and the second pair of paired magnets of the sleeve improves the texture and flavor of the liquid blended within the beverage container;
such that the second pair of magnets has the first magnet of the second pair of paired magnets positioned in one of the sides of the plurality of sides of the sleeve, said side being 90 degrees off from the side into which the first pair of paired magnets is inserted, with the second magnet of the second pair of paired magnets positioned in the opposite side of the sleeve from the first magnet of the second pair of paired magnets;
wherein the first magnet of the second pair of magnets is oriented so that its positive pole is oriented toward and facing the negative pole of the second magnet of the second pair of magnets that is located on the opposite location around the sleeve;
wherein the second pair of magnets in the sleeve act upon each other to create a magnetic field within the liquid in the beverage container; and
said magnet fields of the first pair of paired magnets and the second pair of paired magnets act upon the liquid in the beverage container to improve the flavor and texture of the liquid.
